(19) United States
(12) Patent Application Publication
(10) Pub. No.: US 2017/0111691 A1
(43) Pub. Date: Apr. 20, 2017

(54) METHOD FOR STARTING A SMART TV AND SMART TV

(71) Applicant: HISENSE MOBILE COMMUNICATIONS TECHNOLOGY CO., LTD., Qingdao (CN)

(72) Inventor: Jian ZUO, Qingdao (CN)

(21) Appl. No.: 15/391,011

(22) Filed: Dec. 27, 2016

(30) Foreign Application Priority Data
Jan. 26, 2016 (CN) 201610052479.2

(51) Int. Cl. H04N 21/443; H04N 21/462; H04N 21/431; H04N 21/4363; H04N 21/439; H04N 21/44; H04N 21/482; H04N 21/45

(52) U.S. Cl. CPC H04N 21/4432; H04N 21/482; H04N 21/4622; H04N 21/4516; H04N 21/43635; H04N 21/439; H04N 21/44; H04N 21/431

(57) ABSTRACT

Disclosed are a method for starting a smart TV and a smart TV. The method includes: starting a system kernel of a smart TV after the smart TV is powered up; starting simultaneously the Android operating system and a TV system on the smart TV, the TV system being configured to control TV signals received through at least one signal source interface of the smart; displaying the TV signals received through the signal source interface on the display screen after the starting process of the TV system is completed.

### CROSS-REFERENCE TO RELATED APPLICATION

This application claims the benefit and priority of Chinese Patent Application No. 201610052479.2 filed Jan. 26, 2016. The entire disclosure of the above application is incorporated herein by reference.

### FIELD

The present disclosure relates to the field of intelligent devices, particularly to a method for starting a smart TV and a smart TV.

### BACKGROUND

This section provides background information related to the present disclosure which is not necessarily prior art.

With the development of technology, there is a tendency to make TVs intelligent. Apart from conventional functions such as displaying videos or games, a smart TV could also connect to network and carry out a cross-platform search among TV, network and programs.

Currently, the operating system in most smart TVs is Android. The TV service of a smart TV is one of the services in Android, and all services in Android are started in turn after the service incubator called zygote and the service manager of Android are started.

### SUMMARY

This section provides a general summary of the disclosure, and is not a comprehensive disclosure of its full scope or all of its features.

In an aspect, some embodiments of the disclosure provide a method for starting a smart TV, including:

Starting a system kernel of a smart TV after the smart TV is powered

up; starting simultaneously an Android operating system and a TV system on the smart TV, the TV system being configured to control TV signals received through at least one signal source interface of the smart TV;

displaying the TV signals received through the signal source interface on the display screen after the starting process of the TV system is completed.

In another aspect, some embodiments of the disclosure further provide a smart TV, including:

at least one processor;

a memory communicably connected with the at least one processor, wherein:

the memory stores instructions executable by the at least one processor, wherein the instructions, when executed by the at least one processor, cause the at least one processor to:

start a system kernel of a smart TV after the smart TV is powered up;

start simultaneously an Android operating system and a TV system on the smart TV, the TV system being configured to control TV signals received through at least one signal source interface of the smart TV;

display the TV signals received through the signal source interface on the display screen after the starting process of the TV system is completed.

In another aspect, some embodiments of the disclosure further provide a nonvolatile computer-readable storage medium which stores computer instructions that, when executed by a computer, cause the computer to:

start a system kernel of a smart TV after the smart TV is powered up;

start simultaneously an Android operating system and a TV system on the smart TV, the TV system being configured to control TV signals received through at least one signal source interface of the smart TV;

display the TV signals received through the signal source interface on the display screen after the starting process of the TV system is completed.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic flowchart of a method for starting a smart TV in accordance with related art;

FIG. 2 is a schematic flowchart of a method for starting a smart TV in accordance with some embodiments of the disclosure;

FIG. 3 is a schematic flowchart of a method for starting a smart TV in accordance with some embodiments of the disclosure;

FIG. 4 illustrates a time axis of the starting of a smart TV in accordance with related art, in contrast with a time axis of the starting of a smart TV in accordance with some embodiments of the disclosure;

FIG. 5 is a schematic diagram of a time axis of the starting of a smart TV;

FIG. 6 is a schematic diagram of a time axis of the starting of a smart TV in accordance with some embodiments of the disclosure;

FIG. 7 is a schematic diagram of a smart TV in accordance with some embodiments of the disclosure;

FIG. 8 is a schematic diagram of the structure of hardware of a smart TV in accordance with some embodiments of the disclosure; and

FIG. 9 is a schematic diagram of the structure of hardware of another smart TV in accordance with some embodiments of the disclosure.

Corresponding reference numerals indicate corresponding parts or features throughout the several views of the drawings.

### DETAILED DESCRIPTION

Example embodiments will now be described more fully with reference to the accompanying drawings.

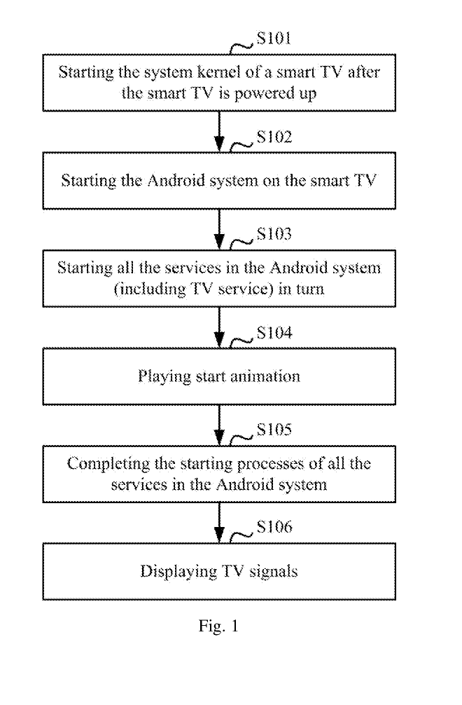

As illustrated in FIG. 1, the starting process of a smart TV includes:

S101: starting the system kernel of a smart TV after the smart TV is powered up;

S102: starting the Android system on the smart TV;

S103: starting all the services in the Android system (including TV service) in turn;

S104: playing start animation;

S105: completing the starting processes of all the services in the Android system;

S106: displaying TV signals.

In embodiments of the disclosure, the TV service is separated from the Android system as a TV system, and the Android system and the TV system are started simultaneously. thus shortening the time a user would spend waiting for a TV signal and improving the user experience , since the time needed for starting the TV system is far less than the time needed for starting the Android system.

The embodiments of the disclosure are further described in detail below, with reference to the accompanying drawings, where the embodiments are not construed as limiting the disclosure, but only describing and explaining the disclosure.

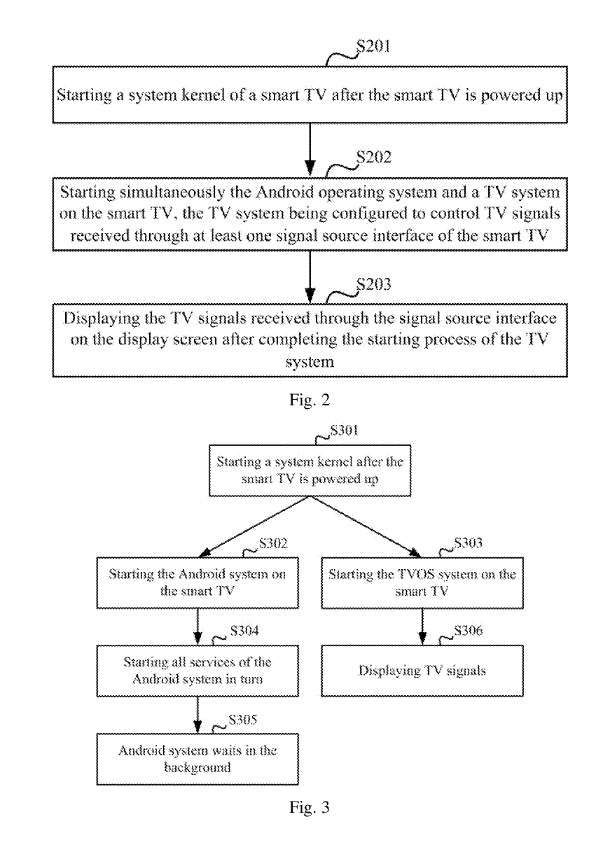

Some embodiments of the disclosure provide a method for starting a smart TV, and as illustrated in FIG. 2, the method includes:

S201: starting a system kernel of a smart TV after the smart TV is powered up;

Specifically, after the smart TV is powered up, a system kernel of the Linux system on the smart TV is started.

S202: starting simultaneously the Android operating system and a TV system on the smart TV, the TV system being configured to control TV signals received through at least one signal source interface of the smart TV.

S203: displaying the TV signals received through the signal source interface on the display screen after completing the starting process of the TV system.

In the methods and devices provided by the embodiments of the disclosure, the TV service is separated from the Android system as a TV system, the Android system and the TV system are started simultaneously, and the TV signals received through at least one signal source interface are displayed on the display screen of the smart TV after the TV system has completed its starting. In related art, the TV service conforms to a framework protocol of Android system; the TV service needs to call an interface of the Android system so as to call a kernel interface through the Android system, thus controlling the bottom drive and hardware. While in the disclosure, the TV system is a Linux program independent from the Android system, and the TV system may call a kernel interface directly so as to control the bottom drive and hardware. Therefore, when the TV system has completed its starting process, the TV signals received through the signal source interface could be displayed on the display screen of the smart TV. In the disclosure, the TV system calls a kernel interface directly, thereby running in parallel with the Android system.

In the embodiments of the disclosure, the Android system and the TV system are started simultaneously, and the starting time of the TV system is approximately 10 seconds, which is much shorter than the starting time of the Android system, therefore, the Android system is still in its starting process when the TV system has completed its starting process. Because once the TV system has completed its starting process, TV signals received through the signal source interface could be displayed on the display screen of the smart TV, the time a user would spend waiting for a TV signal is shortened and the user experience is improved.

In the embodiments of the disclosure, the signal source interface includes but is not limited to at least one of the following interfaces:

Analog TV (ATV) interface, Digital TV (DTV) interface, High Definition Multimedia Interface (HDMI), Audio and Video (AV) interface, component video interface, and Universal Serial Bus (USB) interface.

According to any one of the embodiments above, starting the TV system in S202 includes the following procedure:

determining an initial signal source interface;

receiving audio signals or video signals through the initial signal source interface, and decoding the received audio signals or video signals to obtain TV signals that could be displayed on the smart TV.

In some embodiments of the disclosure, during starting the TV system, an initial signal source interface is determined firstly, then audio signals or video signals through the initial signal source interface are received, and the received audio signals or video signals are decoded, so that decoded TV signals could be displayed on the display screen of the smart TV.

In implementation of the disclosure, determining an initial signal source interface includes the following three optional schemes.

Scheme 1: choosing a default signal source interface of the TV system as the initial signal source interface.

Specifically, the TV system usually has a default signal source interface, which means, when the TV system is being started, audio signals or video signals are received from the default signal interface first.

In this scheme, if neither audio signal nor video signal is received from the default signal source interface, determining an initial signal source interface includes:

choosing any one of the other signal source interfaces as the initial source interface until an audio signal or a video signal is received, or

choosing one of the other signal source interfaces as the initial source interface in a preference order configured by the TV system, until an audio signal or a video signal is received, or

providing the user with an interface of signal source interface selection, receiving the signal source interface selected by the user through the interface of signal source interface selection, and determining the signal source interface selected by the user as the initial signal source interface.

Scheme 2: choosing the signal source interface lastly used as the initial signal source interface.

In this scheme, the smart TV saves the signal source interface lastly used by the user and when starting the TV system, the signal source interface lastly used by the user is chosen as the initial signal source interface.

Scheme 3: choosing the signal source interface selected by a user as the initial signal source interface.

In this scheme, an interface of signal source interface selection is provided to the user, so that the user could select a signal source interface corresponding to the TV signal he/she needs to watch, from the interface of signal source interface selection; then the signal source interface, selected by the user from the interface of signal source interface selection, is received and the signal source interface selected by the user is chosen as the initial signal source interface.

With this scheme, the signal source interface selected by the user may be started as needed by the user, thereby satisfying the user's need and improving the user experience.

The method for starting a smart TV is described in detail below according to the embodiments of the disclosure.

Some embodiments of the disclosure provide a method for starting a smart TV, as illustrated in FIG. 3, the method including:

S301: starting a system kernel after the smart TV is powered up.

S302: starting the Android system on the smart TV.

S303: starting the TVOS system (i.e. the TV system) on the smart TV.

In the embodiments, S302 and S303 are executed in parallel.

S304: starting all services of the Android system in turn during starting process the Android system, where in the present disclosure, there is no TV service included in all services of the Android system.

S305: Android system waits in the background, after starting processes of all services are completed.

S306: displaying TV signals after the starting process of the TVOS system is completed.

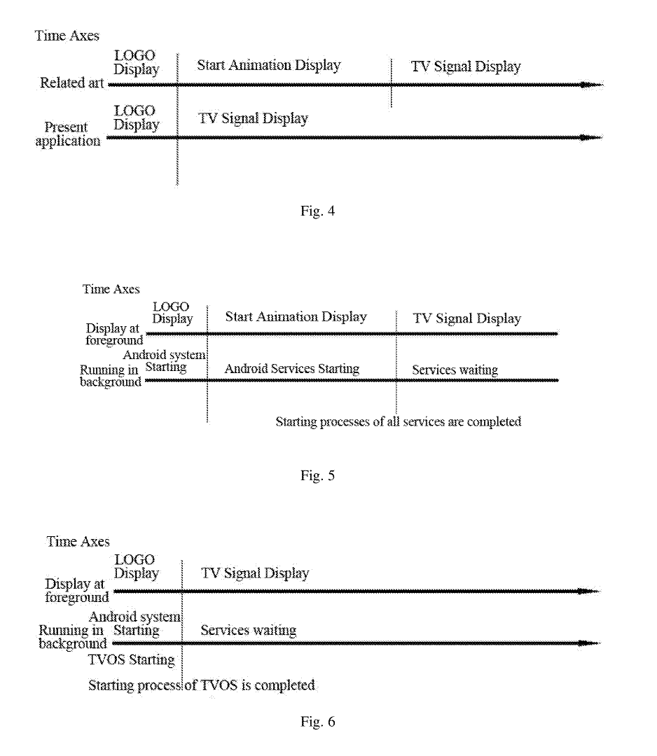

For example, FIG. 4 illustrates a time axis of starting of a smart TV according to related art, in contrast with a time axis of starting of a smart TV according to some embodiments of the disclosure. According to related art, when a smart TV is being started and the Android system is running, the LOGO of the smart TV could be displayed on the display screen of the smart TV (i.e. display at the foreground); during all the services in the Android system (there is no TV service in all services of Android system) are started in turn, booting animation is displayed on the display screen of the smart TV; after all the services in the Android system have completed starting process, TV signals could be displayed on the display screen of the smart TV, as illustrated in FIG. 5. According to the embodiments of the disclosure, during a smart TV is started, the Android system and the TVOS system are running in parallel, and the LOGO of the smart TV is displayed on the display screen of the smart TV; after the TVOS system has completed its starting process, TV signals are displayed on the display screen of the smart TV, at this time not all the services in the Android system have completed their starting process, as illustrated in FIG. 6. Because the starting time of the TV system is much shorter than the starting time of the Android system, the time a user would spend waiting for a TV signal is shortened and the user experience is improved.

The processing flow of the method above could be executed by a software program which is stored in a storage medium and executes the method above when called.

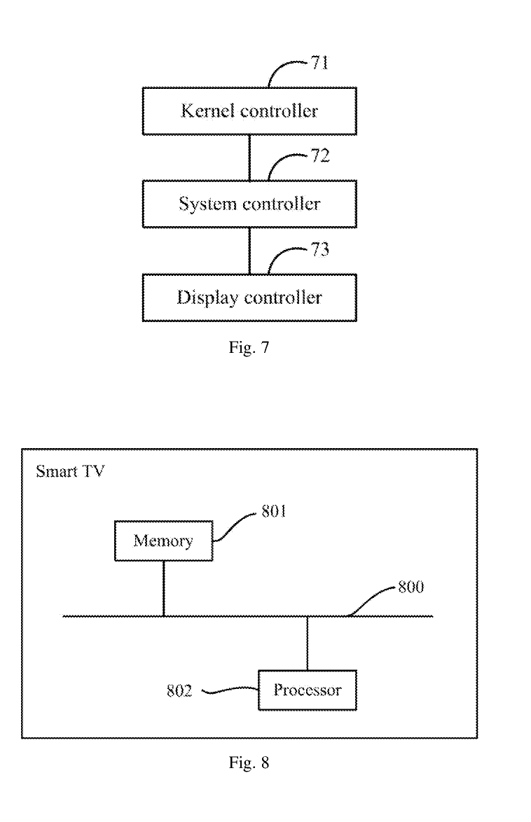

Based on the same inventive conception, some embodiments of the disclosure provide a smart TV. Because the principles the smart TV uses to solve problems is similar to the method for starting a smart TV illustrated by FIG. 2, the implementation of the smart TV could take the implementation of the method as reference, and repeated parts would not be described here. As illustrated in FIG. 7, the smart TV includes:

a kernel controller 71, configured to start a system kernel of the smart TV after the smart TV is power up;

a system controller 72, configured to start simultaneously the Android operating system and a TV system on the smart TV, the TV system being configured to control TV signals received through at least one signal source interface of the smart TV;

a display controller 73, configured to display TV signals received through the signal source interface on the display screen after the starting of TV system is completed.

In the smart TV provided by the embodiments of the disclosure, the TV service is separated from the Android system as TV system, the Android system and the TV system are started simultaneously, and TV signals received through the signal source interface are displayed on the display screen of the smart TV once the TV system has completed its starting. Because the starting time of the TV system is approximately 10 seconds, which is much shorter than the starting time of the Android system, the time a user would spend waiting for a TV signal is shortened and the user experience is improved.

In some embodiments of the disclosure, the signal source interface includes at least one of an analog TV interface, a digital TV interface, a high definition multimedia interface (HDMI), an audio and video (AV) interface, a component video interface, and a universal serial bus (USB) interface.

According to any one of the embodiments above, the system controller 72 configured to start the TV system is specifically configured to:

determine an initial signal source interface;

receive audio signals or video signals through the initial signal source interface, and decode the received audio signals or video signals to obtain TV signals that could be displayed on the smart TV.

In some embodiments of the disclosure, the system controller 72 configured to determine an initial signal source interface is specifically configured to:

choose a default signal source interface of the TV system as the initial signal source interface; or

choose the signal source interface lastly used as the initial signal source interface; or

choose the signal source interface selected by a user as the initial signal source interface.

In some embodiments of the disclosure, before choosing the signal source interface selected by the user as the initial signal source interface, the system controller 72 is further configured to:

provide the user with an interface of signal source interface selection;

receive the signal source interface selected by the user from the interface of signal source interface selection.

Based on the same inventive conception, some embodiments of the disclosure provide a smart TV. As illustrated in FIG. 8, the smart TV includes a memory 801 and a processor 802, where the memory 801 and the processor 802 could be connected via a bus 800, or via a specialized connection wire. As an example, they are connected via the bus 800 in FIG. 8. The memory 801 is configured to store instructions and the processor 802 is configured to execute instructions stored in the memory 801 to perform:

starting a system kernel of a smart TV after the smart TV is powered up;

starting simultaneously an Android operating system and a TV system on the smart TV, the TV system being configured to control TV signals received through at least one signal source interface of the smart TV;

displaying the TV signals received through the signal source interface on the display screen after the starting process of TV system is completed.

In some embodiments of the disclosure, the signal source interface includes at least one of an analog TV interface, a digital TV interface, a high definition multimedia interface (HDMI), an audio and video (AV) interface, a component video interface, and a universal serial bus (USB) interface.

In some embodiments of the disclosure, starting the TV system includes:

determining an initial signal source interface;

receiving audio signals or video signals through the initial signal source interface, and decode the received audio signals or video signals to obtain TV signals that could be displayed on the smart TV.

In some embodiments of the disclosure, determining an initial signal source interface includes:

choosing a default signal source interface of the TV system as the initial signal source interface, or

choosing the signal source interface lastly used as the initial signal source interface, or

choosing the signal source interface selected by a user as the initial signal source interface.

In some embodiments of the disclosure, before choosing the signal source interface selected by the user as the initial signal source interface, the at least one processor is further configured to:

provide the user with an interface of signal source interface selection;

receive the signal source interface selected by the user from the interface of signal source interface selection.

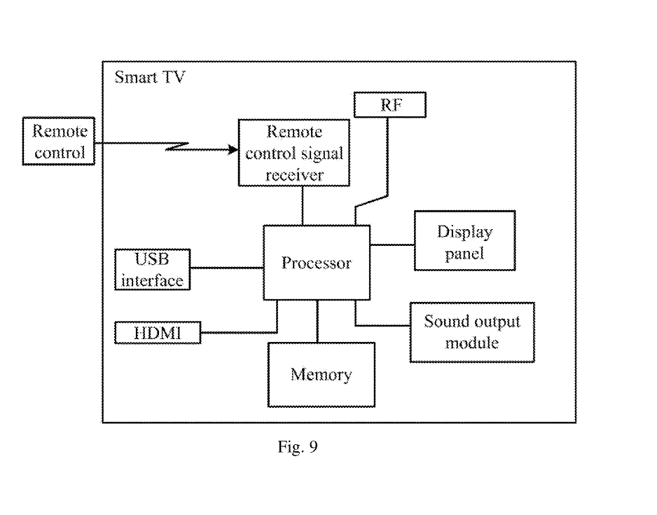

As illustrated in FIG. 9, the smart TV includes a memory, an input unit, an output unit, one or more processors and other components. Those skilled in the art can appreciate that the smart TV will not be limited to the structure of the smart TV illustrated in FIG. 9, but can include more or less components than those as illustrated, or combine some components or be configured with different components, where:

The memory is configured to store software programs and modules, and the processor is configured to run the software programs and modules stored in the memory to thereby perform various functional applications and data processing. The memory may include high speed random access memory, and further include a nonvolatile memory, such as at least one disc storage device, flash memory device, or other volatile solid storage devices. In addition, the memory could include a memory controller to provide an access of the processor and the input unit to the memory.

The processor is the control center of the smart TV. It connects every part of the smart TV by using various interfaces and circuits, runs or executes software programs and/or modules stored in the memory, and invokes data stored in the memory to perform various functions of the smart TV and data processes, thereby monitoring the TV as a whole. Optionally, the processor could include one or more processing cores. Optionally, the processor could be integrated with an application processor and a modulation-demodulation processor, where the application processor is mainly responsible for processing operating systems, user interfaces, application programs and so on, and the modulation-demodulation processor is mainly responsible for processing wireless communications. It could be understood that the modulation-demodulation processor may not be integrated into the processor.

The smart TV could include an input unit such as a TV broadcast receiver, a high definition multimedia interface, USB interface, audio and video input structure and so on. The input unit could further include a remote control receiver which receives signals sent from a remote control. Furthermore, the input unit could include a touch sensitive surface and some other devices. The touch sensitive surface could be resistive, capacitive, infra, surface acoustic wave and so on. And the some other devices could include but are not limited to one or more of a physical keyboard, a function key (e.g., a volume control press key, a switch key, etc.), a trackball, a mouse, an operating lever and so on.

The output unit is configured to output sound signals, video signals, warning signals, vibration signals and so on. The output unit could include a display panel, a sound output module and so on. The display panel could be configured to display information input by a user, information provided for a user and various graphic user interfaces, which could be constituted by graphics, texts, icons, videos and any of their combinations. For example, the display panel could be Liquid Crystal Display (LCD), Organic Light-Emitting Diode (OLED), flexible display, three dimensional display, CRT, plasma display panel and so on.

The smart TV could further include at least one kind of sensor (not shown in the figures), such as light sensor, motion sensor or other sensors. Specifically, the light sensor could include an environmental light sensor and a proximity sensor, where the environmental light sensor could adjust the brightness of the display panel according to the brightness of the environmental light, the proximity sensor could turn off the display panel and/or backlight when the smart TV moves to a certain position. The smart TV could be fitted with other sensors such as a gyroscope, a barometer, a hygrometer, a thermometer, an infrared sensor and so on.

The smart TV could further include an audio circuit (not shown in the figures), and a loud speaker or a microphone could provide an audio interface between a user and the smart TV. The audio circuit could send to the loudspeaker the electrical signal transformed from received audio data, the loudspeaker may convert the electrical signal into a sound signal and output it. On the other hand, the microphone converts a collected sound signal into an electrical signal, the audio circuit receives the electrical signal, converts it into audio data, and outputs the audio data to the processor to be processed and then sent to for example another terminal, or the audio circuit outputs the audio data to the memory for further processing. The audio circuit might further include an earphone jack to provide communications between external earphones and the smart TV.

Furthermore, the smart TV could include a Radio Frequency (RF) circuit. The RF circuit is configured to receive and send a signal. Usually, an RF circuit includes but is not limited to an antenna, at least one amplifier, a tuner, one or several oscillators, a subscriber identification module (SIM) card, a transceiver, a coupler, a low noise amplifier (LNA), a diplexer and so on. In addition, the smart TV could include a camera, a Bluetooth module and so on.

Furthermore, the smart TV could include a wireless fidelity (WiFi) module (not shown in the figures). WiFi is a technology of short-range wireless transmission technology and the smart TV could assist a user in receiving and sending emails, browsing a webpage, visiting stream media, etc. through the WiFi module. The WiFi module also provides a user with wireless wideband internet visit. It could be understood that the WiFi module is not necessarily required for the smart TV, but can be omitted as needed without changing the essence of the disclosure.

Based on the same disclosed conception, embodiments of the disclosure further provide a nonvolatile computer storage medium which stores computer-executable instructions for performing any one of the methods for starting a smart TV described above.

Those ordinarily skilled in the art can appreciate that the embodiments of the disclosure could be provided as methods, systems, or computer program products. Therefore, the disclosure could adopt the form of absolute hardware embodiments, absolute software embodiments, or embodiments combining software and hardware aspects. In addition, the disclosure could adopt the form of a computer program product carried out on one or several computer useable storage media (including but not limited to disc memory, CD-ROM, optical memory and so on) which includes computer useable program codes.

The disclosure is described with reference to flow charts and/or block diagrams of the methods, the devices (systems) and the computer program products according to the embodiments of the disclosure. It should be understood that each operation and/or block of the flow charts and/or the block diagrams, as well as combinations of the operations and/or the blocks of the flow charts and/or the block diagrams, can be implemented through computer program instructions, where these computer program instructions could be provided to a general purpose computer, a specialized computer, an embedded processor, or processors of other programmable data processing devices to generate a machine, so that by instructions executed by the processor of the computer or another programmable data processing device, an apparatus is generated which is configured to implement the functions specified in one or several operations of the flow charts and/or one or more blocks of the block diagrams.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for starting a smart TV, comprising:
starting a system kernel of a smart TV after the smart TV is powered up;
starting simultaneously an Android operating system and a TV system on the smart TV, the TV system being configured to control TV signals received through at least one signal source interface of the smart TV;
displaying the TV signals received through the signal source interface on the display screen after the starting process of the TV system is completed.

2. The method according to claim 1, wherein the signal source interface comprises at least one of an analog TV interface, a digital TV interface, a High Definition Multimedia Interface (HDMI), an Audio and Video (AV) interface, a component video interface, and a Universal Serial Bus (USB) interface.

3. The method according to claim 1, wherein starting the TV system comprises:
determining an initial signal source interface;
receiving audio signals or video signals through the initial signal source interface, and decoding the received audio signals or video signals to obtain the TV signals that could be displayed on the smart TV.

4. The method according to claim 3, wherein determining an initial signal source interface comprises:
choosing a default signal source interface of the TV system as the initial signal source interface, or
choosing the signal source interface lastly used as the initial signal source interface, or
choosing the signal source interface selected by a user as the initial signal source interface.

5. The method according to claim 4, wherein before choosing the signal source interface selected by a user as the initial signal source interface, the method further comprises: providing the user with an interface of signal source interface selection;
receiving the signal source interface selected by the user from the interface of signal source interface selection.

6. A smart TV, comprising:
at least one processor;
a memory communicably connected with the at least one processor, wherein:
the memory stores instructions executable by the at least one processor, wherein the instructions, when executed by the at least one processor, cause the at least one processor to:
start a system kernel of a smart TV after the smart TV is powered up;
start simultaneously an Android operating system and a TV system on the smart TV, the TV system being configured to control TV signals received through at least one signal source interface of the smart TV;
display the TV signals received through the signal source interface on the display screen after the starting process of the TV system is completed.

7. The smart TV according to claim 6, wherein the signal source interface comprises at least one of an analog TV interface, a digital TV interface, a high definition multimedia interface (HDMI), an audio and video (AV) interface, a component video interface, and a universal serial bus (USB) interface.

8. The smart TV according to claim 6, wherein the instructions further cause the at least one processor to:
determine an initial signal source interface;
receive audio signals or video signals through the initial signal source interface, and decode the received audio signals or video signals to obtain the TV signals that could be displayed on the smart TV.

9. The smart TV according to claim 8, wherein the instructions further cause the at least one processor to:
choose a default signal source interface of the TV system as the initial signal source interface, or
choose the signal source interface lastly used as the initial signal source interface, or choose the signal source interface selected by a user as the initial signal source interface.

10. The smart TV according to claim 9, wherein before choosing the signal source interface selected by a user as the initial signal source interface, the instructions further cause the at least one processor to:
provide the user with an interface of signal source interface selection;
receive the signal source interface selected by the user from the interface of signal source interface selection.

11. A nonvolatile computer-readable storage medium which stores computer instructions that, when executed by a computer, cause the computer to:
start a system kernel of a smart TV after the smart TV is powered up;
start simultaneously an Android operating system and a TV system on the smart TV, the TV system being configured to control TV signals received through at least one signal source interface of the smart TV;
display the TV signals received through the signal source interface on the display screen after the starting process of the TV system is completed.
